(19) United States
(12) Patent Application Publication
(10) Pub. No.: US 2013/0285781 A1
(43) Pub. Date: Oct. 31, 2013

(54) NANO DIELECTRIC FLUIDS

(71) Applicant: Weijun Yin, Niskayuna, NY (US)

(72) Inventor: Weijun Yin, Niskayuna, NY (US)

(73) Assignee: GENERAL ELECTRIC COMPANY, SCHENECTADY, NY (US)

(21) Appl. No.: 13/459,638

(22) Filed: Apr. 30, 2012

(51) Int. Cl. H01F 27/12; H01B 3/24; H01B 3/20; H01B 3/22; B82Y 30/00

(52) U.S. Cl. 336/58; 252/572; 977/773

(57) ABSTRACT

A system is provided. The system includes about 99.9 Wt % to about 95 Wt % of an insulating liquid, and about 0.1 Wt % to about 5 Wt % of insulating, inorganic, non-magnetic nanoparticles. Another aspect of the invention includes an electrical apparatus. The electrical apparatus includes an insulation system that comprises a dielectric fluid having about 99.9 Wt % to about 95 Wt % of an insulating liquid, and about 0.1 Wt % to about 5 Wt % of insulating, inorganic, non-magnetic nanoparticles.

### BACKGROUND

The invention relates generally to dielectric fluids. More particularly, the invention relates to insulating dielectric fluids that include insulating nanoparticles.

The stability of an electric power apparatus is often limited by the dielectric fluids used in the apparatus. Dielectric fluids generally serve two functions in the electric power apparatus. One function is electrical insulation, and another is cooling of the apparatus. The insulation and cooling performance of dielectric fluids are important to an electric power apparatus.

The cooling property of the dielectric fluid is dependent on its thermal conductivity and viscosity. Higher thermal conductivity and lower viscosity are desirable to effectively transfer the generated heat, and thereby maintain the temperature within the electric power apparatus at an acceptable level.

A transformer is one example of such an electric power apparatus. Voltage and power ratings of the transformer are currently limited by the dielectric strength of the liquid insulation, and its thermal capability. The thermal capability of the insulating liquid is normally low, due to its relatively low thermal conductivity. With increased demand for power transmission and distribution infrastructure, especially with increasing usage of plug-in hybrid electric vehicles (PHEV), higher current loading and faster heat transfer are desirable. Therefore, reliable high power distribution transformers require dielectric fluids with improved thermal and dielectric properties.

### BRIEF DESCRIPTION

Briefly, in one embodiment, a system is provided. The system includes a dielectric fluid comprising about 95 Wt % to about 99.9 Wt % of an insulating liquid, and about 0.1 Wt % to about 5 Wt % of electrically insulating inorganic, non-magnetic nanoparticles.

In another embodiment, an electrical apparatus is provided. The electrical apparatus includes an electrical insulation system that comprises a dielectric fluid. The dielectric fluid includes about 95 Wt % to about 99.9 Wt % of an insulating liquid, and about 0.1 Wt % to about 5 Wt % of electrically insulating inorganic, non-magnetic nanoparticles.

### DRAWINGS

These and other features, aspects, and advantages of the present invention will become better understood when the following detailed description is read with reference to the accompanying drawings, in which like characters represent like parts throughout the drawings, wherein:

FIG. 1 depicts a schematic of an electrical apparatus, according to one embodiment of the invention;

FIG. 2 shows thermal conductivity values for selected nanoparticles used in the nano dielectric fluids;

FIG. 3 shows a comparison of AC breakdown strength of mineral oils without nanoparticles, and mineral oils with 5% nano alumina by weight;

FIG. 4 compares AC breakdown strength between mineral oil without nanoparticles, and with nanoparticles;

FIG. 5 shows breakdown voltage versus water content, between mineral oil without nanoparticles, and with nanoparticles;

FIG. 6 depicts Weibull plots of AC breakdown values of silicone oils without any nano particles, and with TiO₂;

FIG. 7 depicts a comparison of heat transfer properties between mineral oil without nanoparticles, and with nanoparticles; and

FIG. 8 depicts a comparison of impulse breakdown properties between mineral oil without nanoparticles, and with nanoparticles.

### DETAILED DESCRIPTION

One or more specific embodiments of the present invention are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following specification and the claims that follow, the singular forms “a”, “an” and “the” include plural referents unless the context clearly dictates otherwise.

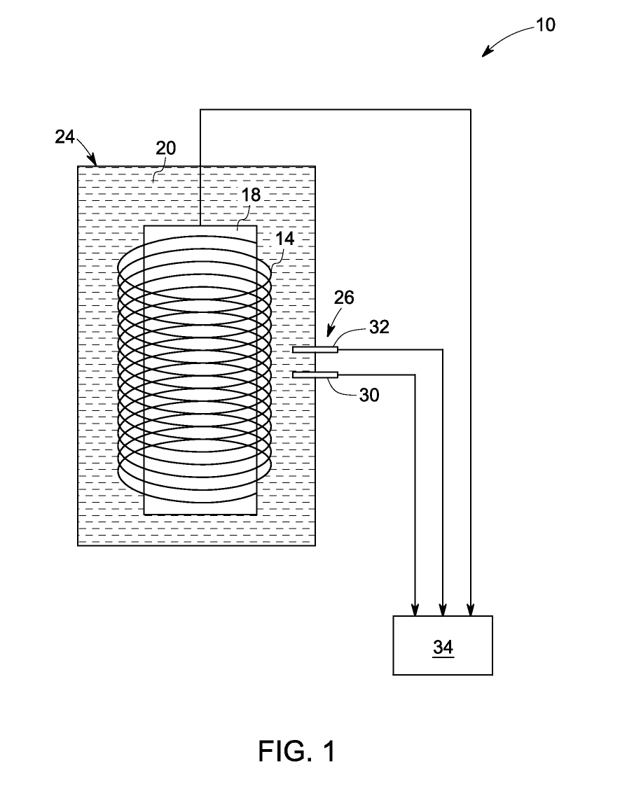

Embodiments of the present invention provide a dielectric fluid. The dielectric fluid includes an insulating liquid and one or more types of nanoparticles. In one embodiment, the dielectric fluid including the insulating liquid and the nanoparticles is called a “nano dielectric fluid”. The nano dielectric fluid may be used in an electrical apparatus as shown in FIG. 1. Referring to FIG. 1, a schematic of a power transformer according to an embodiment of the present invention is depicted generally as 10. It should be noted that many different types of electrical transformers, available in the art, are amenable to the fluids described in different embodiments of the invention. Further, it should be understood that the dielectric fluids for embodiments of the invention may also be useful for other types of electrical equipment, such as distribution transformers, regulating transformers, shunt reactors, converter transformers, instrument transformers, generating station units, and power transformers. One specific example of an electrical apparatus is a voltage/current transformer. Other specific examples of the electrical apparatus include transformers, capacitors, X-ray generators, and circuit breakers.

One of several windings 14, made of an insulated conductive material, is wrapped around a magnetic core 18. The windings 14 and magnetic core 18 are immersed in the dielectric fluid 20 in a container 24. Those skilled in the art understand that the apparatus in FIG. 1 is merely exemplary; and various ways in which the insulating fluids are located within, and circulated through, transformers, can be envisaged. The transformer 10 also includes various sensors for use in calculating the moisture content of the dielectric fluid insulation 20. For example, a moisture-in-oil probe 26 comprises a water-in-oil sensor 30 and a temperature sensor 32, to measure the oil temperature at the water-in-oil sensor 30 location. The transformer 10 may further include a processor 34 in electrical communication with at least the foregoing sensors 30, 32, for receiving data from the sensors, and processing the data. As noted earlier, the dielectric fluid in the electrical apparatus primarily has two functions: electrical insulation of the apparatus, and heat removal from the apparatus. In one embodiment, the dielectric fluid includes an insulating liquid and nanoparticles. As used herein, “insulating liquid” means that the conductivity of the liquid is less than about 10⁻⁷ S/m. In one embodiment, the insulating liquid has the conductivity less than about 10⁻¹⁰ S/m. The high insulating property of the liquid enhances the ability of the electrical apparatus to resist electrical breakdowns. In one embodiment, the dielectric fluid comprises about 95 Wt % to about 99.9 Wt % insulating liquid. In one specific embodiment, the dielectric fluid comprises about 96 Wt % to about 99 Wt % of insulating liquid.

In one embodiment, the nanoparticles present in the fluid are insulating, inorganic, and non-magnetic materials. As used herein, “insulating particles” means that the conductivity of the particles is less than about 10⁻³ S/m (10⁻⁵ S/cm). It is often desirable that the nanoparticles be electrically insulating, rather than electrically conductive, so that the overall electrical conductivity of the fluid does not increase. Otherwise, an increase in the conductivity of the fluid may increase the probability of an electrical breakdown in an apparatus that includes such a dielectric fluid.

As used herein, the term “inorganic material” means that a substantial part of the material includes metallic oxides, metallic nitrides or ceramics. As used herein, “substantial part” is defined as more than about 90 wt %. As used herein, the “non-magnetic” characteristic refers to nanoparticles that are typically not magnetized under the magnetic field, i.e., they do not show an appreciable amount of attractive or repulsive force on other materials under magnetic field.

In one embodiment, the nanoparticles are present in a range from about 0.1 Wt % to about 5 Wt % of the dielectric fluid, and in some specific embodiments, from about 0.5 Wt % to about 3 Wt %. In one particular embodiment, the nanoparticles are present in a range from about 1 Wt % to about 2 Wt % of the dielectric fluid. As noted above, in a given fluid, the volume of insulating liquid is relatively high, as compared to the number of nanoparticles present. However, it is usually very desirable that the number of nanoparticles and the particular type of nanoparticles not provide an electrical conductivity higher than about 10⁻³ S/m. This is because the higher conductivity may undesirably facilitate a conduction path for any stray current in the dielectric fluid. Therefore, a pre-determined, specific balance between the conductivity of the nanoparticles and the amount of nanoparticles present in the dielectric fluid is desirable. In one embodiment, the conductivity of the nanoparticles is equal to or less than about 10⁻⁴ S/m. In a further embodiment, the conductivity of the nanoparticles is equal to or less than about 10⁻⁸ S/m. In one embodiment, the nanoparticles used herein are undoped. As used herein, “undoped” means that there are no additional elements intentionally added to change the electrical or magnetic properties of the nanoparticles.

In one embodiment, the insulating liquid comprises a mineral oil, high molecular weight hydrocarbon oil, silicone oil, a vegetable oil, synthetic ester oil, natural ester oil, a synthetic hydrocarbon liquid, perfluoropolymer liquid, or various other insulating liquids.

In one embodiment, the insulating, inorganic, non-magnetic nanoparticles comprise aluminum oxide, chromium oxide, titanium oxide, magnesium oxide, silicon oxide, or any combination thereof. For example, in one embodiment, the fluid includes about 1 Wt % to about 2 Wt % of chromium oxide. In another example, the fluid includes about 1 Wt % to about 4 Wt % of aluminum oxide, and in another particular embodiment, the fluid includes from about 1 Wt % to about 2 Wt % of titanium oxide. In some embodiments, aluminum oxide is a preferred nanoparticle, due in part to its flexibility in use. For example, aluminum oxide often appears to be effective over a relatively wide range of concentrations in various insulting liquids. In other embodiments, titanium oxide in silicone oil is a particularly preferred system, as it noticeably increases the breakdown-strength of the dielectric fluid, along with some improvement in thermal conductivity and moisture stability.

The particle size of the nanoparticles in the fluid may vary, depending on the nanoparticle compositions. In one embodiment, the average size of the nanoparticle in the dielectric fluid varies in a range from about 1 nm to about 100 nm. As used herein, the average size of a nanoparticle is the distribution of the particles as observed in particle imaging techniques, and measured along its greatest dimension. For example, if the particles are of circular shape, the greatest dimension is the diameter of the sphere, while if the particles are “rod” shaped, the greatest dimension is the length of the rod. Further, “average” is the calculated mean of the particle sizes observed during imaging, or the median value of the particle distribution curve. In a further embodiment, the average size of the nanoparticle in the dielectric fluid varies in a range from about 5 nm to about 50 nm.

In one embodiment, the nanoparticles are coated with a surfactant. As used herein “coated with a surfactant” means that a surfactant is disposed as a coating on at least a portion of the surface of the nanoparticle. In one embodiment, the surfactant is a hydrophobic surfactant. Covering surfaces of the nanoparticles (at least partially) with a hydrophobic coating aids in the dispersion of the nanoparticles in the insulating liquids, thereby preventing the settling or agglomeration of the nanoparticles in the nano dielectric fluid. The hydrophobic surfactant used herein may include a fatty acid, a silane, a polymer, or any combinations of the aforementioned. Non-limiting examples of polymers that may be used as a coating over the nanoparticles include silicones, a polycarboxylate polymer type surfactants, or alkyl imidazoline type surfactants. In one embodiment, the hydrophobic surfactant comprises oleic acid. In one particular embodiment, an oleic acid surfactant covers at least about 90% of the nanoparticle surfaces.

In one embodiment, the electrical apparatus 10, including the dielectric fluid 30 described hereinabove, exhibits improved thermal and electrical properties as compared to the commonly known insulating liquids used in some electrical apparatuses. In one embodiment, the nano dielectric fluid used herein exhibits an increased thermal conductivity as compared to the insulating liquids commonly used without the nano particles. A high thermal conductivity of the nanoparticles is often desirable for the nano dielectric fluids. In one embodiment, the thermal conductivity of the particles varies from about 5 W/m·K to about 50 W/m·K.

In one embodiment, the viscosity of the dielectric fluid does not significantly increase by the addition of less than about 5% of the nano materials, i.e., the viscosity increase stays within about 10% of the viscosity of dielectric fluid without the nano materials, when measured at a temperature in a range from about 25° C. to 80° C.

One reason for the failure of some high voltage electrical apparatuses is a high electric stress developed under extreme conditions such as lightning. In one embodiment, the nano dielectric fluids address this issue by acting as electron scavengers within a high dielectric field, preventing electrons that are ejected from high voltage electrode, from reaching the opposite ground electrode. This, in turn, enhances the dielectric breakdown strength. For example, in one embodiment, the dielectric breakdown strength of the nano dielectric fluids is greater than the dielectric breakdown strength of the insulating liquid itself.

The dielectric breakdown strength of a dielectric fluid is often a measure of its ability to withstand electric stress, and provide electrical insulation without failure. The breakdown strength of the dielectric fluid is normally influenced by different factors, such as for example, the tendency of the dielectric fluid to produce charge species, moisture absorption, and foreign particle contamination, especially conducting particles. The dielectric constant or the “permittivity”, and the dielectric loss or the “dissipation factor” of the fluid, are preferably low in most embodiments. Furthermore, a permittivity match of the liquid to the solid insulating materials used in the power apparatus is desirable to minimize field concentration due to the disruption of electric field arising from differences in permittivity.

Moisture in the dielectric fluid can be a significant factor in the failure of a high voltage electrical apparatus 10 (FIG. 1). In one embodiment, the electrical apparatus 10, incorporating the nano dielectric fluids, as described above, possesses better moisture stability, as compared to the electrical apparatus having the insulating liquid without the addition of nanoparticles. In one embodiment, the breakdown strength of the electrical apparatus with the nano dielectric fluid is less sensitive to moisture levels, as compared to using insulating liquids without the nanomaterials. In some instances, the nanoparticles appear to adsorb any moisture in the oil, thereby preventing the formation of chain bubbles when energized. In this manner, the adverse effect of moisture on the dielectric fluid's breakdown strength is minimized. In addition to the enhancement of dielectric strength, and moisture stability, in some embodiments, the nano particles in the nano dielectric fluid enhance the thermal conductivity of the dielectric fluid, which can increase the efficiency of heat transfer and cooling.

### EXAMPLES

Several types of nano particles were added in conventional transformer oils. The properties of these nanoparticles were listed in Table 1. Some of those materials listed herein are excellent electrical insulating materials, such as aluminum oxide and titanium dioxide. Others are somewhat less insulating, such as chromium oxide. Moreover, some of the materials are relatively conductive, such as zinc oxide and magnetite.

TABLE 1

| | | | Thermal | Specific | |
|---|---|---|---|---|---|
| | Conductivity | Dielectric | conductivity | gravity | Relaxation |
| | (S/m) | constant | (W/m · K) | (g/cm³) | time (sec) |
| Aluminum oxide | 1.0 × 10⁻¹² | 9.9 | 25 | 4.0 | 42.2 |
| (Al₂O₃) | | | | | |
| Zinc oxide (ZnO) | 10 | 7.4 | 54 | 5.67 | 1.05 × 10⁻¹¹ |
| Magnetite (Fe₃O₄) | 1.0 × 10⁴ | 80 | 37 | 5 | 7.50 × 10⁻¹⁴ |
| Titanium dioxide | 10⁻¹⁰ | 85 | 11.7 | 4 | NA |
| (TiO₂) | | | | | |
| Chromium oxide | 10⁻⁴ | 11⁻¹³ | 10⁻³³ | 5.21 | NA |
| (Cr₂O₃) | | | | | |

### Preparation of Nanofluids

Colloid solutions of alumina and zinc oxide (surface treated with oleic acid) with an average oxide particle size of 20 to 40 nm (Nanodur 2420 and Nanodur 2120), were purchased from Alfa Aesar. A dispersed solution of magnetite with a particle size of about 5 nm was purchased from Strem Chemical. Dry powders of octylsilane treated titanium oxide (T805) and alumina (C805), each with an average particle size of 20 nm, were purchased from Degussa Corp. Dry powders of chromium oxide, with a particle size of 60 nm, were purchased from US Research Nanomaterials, and then surface-treated with oleic acid in the lab.

All these nanoparticles were then separately mixed in with transformer grade mineral oil (MO) such as CrossTrans 206 (T206) or Nytro11GBX (Nytro), natural ester oil (FR3), or silicone oil (PMX 561). Various concentrations of nanoparticles were made in weight percentages of 0.05 to 5% of host transformer oil. The mixed solution was first stirred by a magnetic bar for at least 1 hour, and then followed by sonication for 3 hours, to ensure the particles were well dispersed in the oil.

### Particle Size and Distribution

Particles sizes and the particle size distribution of nanoparticles dispersed in the transformer oil were measured by diluting the solution to less than 0.01% by hexane, and then measuring by a dynamic light scattering instrument. The diluted solution was deposited on a transmission electron microscope (TEM) sample grid, and then vacuum dried. TEM pictures were taken to visually examine the particle size and size range.

### Viscosity Measurement

A commercial dynamic viscometer from Anton Paar AMVn was used to measure the viscosity of nano dielectric fluids at various temperatures.

### Thermal Conductivity Measurement

The transient plane source (TPS) technique, alternatively known as the “hot disk method”, was used to measure the thermal conductivity of the liquid under examination. The diameter of the sensor used was about 3 mm, the diameter of the liquid chamber was about 10 mm, and the depth of the liquid chamber was about 9 mm. A low power level in the range of 0.3 W to 0.5 W was provided by the sensor spiral, to avoid convection in the sample. The measurement was maintained for only about 1 second, to keep the heat diffusion length smaller than the liquid cell radius. The radius of the sensor was chosen to be less than about half of the liquid cell.

### Heat Transfer Measurement

The heat transfer efficiency of three samples (Nytro oil, Nytro oil with 2 wt. % TiO₂, and T₂0₆ oil with 2 wt. % Cr₂O₃) were tested, via heat plate method, with input power at 4.2 W, 9.4 W, and 16.7 W, respectively. During the test, heat was generated in the foil heater, and transferred through the plates by thermal conduction. In the chambers, heat was primarily picked up and transferred by oil through natural convection. The temperature difference between plates is a measure of the combined effect of thermal conduction and natural convection along the heat transfer path.

### AC Breakdown Tests

A Hipotronics AC/DC liquid breakdown tester of 60 OC E-series was used to measure the AC breakdown strength of dielectric liquids according to either ASTM D877 or ASTM D1816. Ten breakdown tests were repeated, per each testing dielectric fluid. A Weibull plot was used to determine the mean average of breakdown strength (63.2%).

### Impulse Surge Breakdown Tests

Impulse breakdown tests were performed using a 1.2/50 μs positive pulse waveform, according to the ASTM D3300 test method.

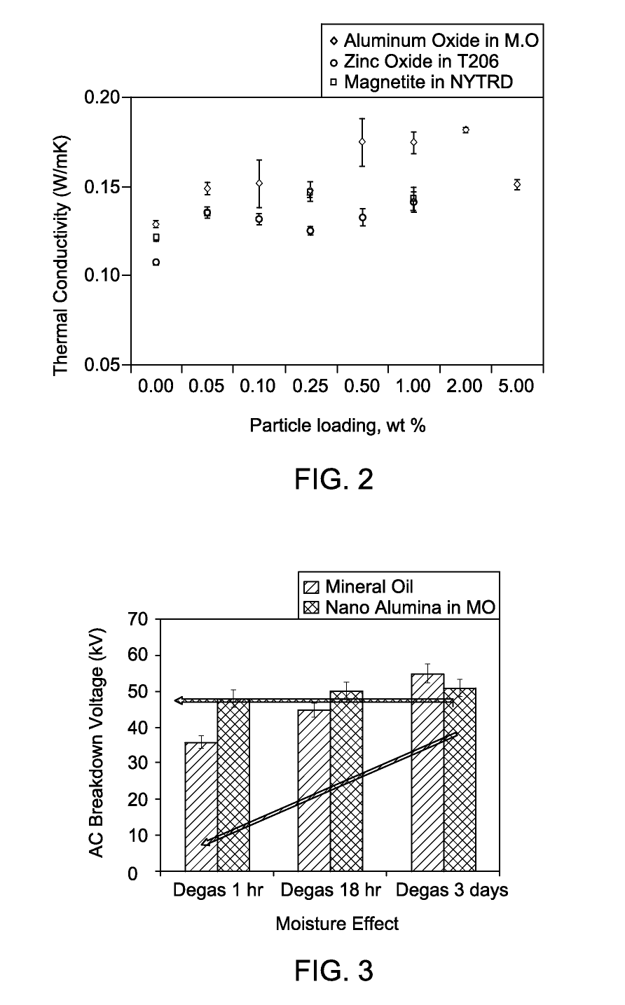

The invention may be more fully illustrated with the example shown in FIG. 2. FIG. 2 shows thermal conductivities of alumina (aluminum oxide), zinc oxide and magnetite mixed with three different types of mineral oils. The thermal conductivities increase with the amount of nano particles in the solutions. Up to about 40% improvement in thermal conductivity was observed with all three types of nano particles, with concentration levels at about 1%-2% by weight.

FIG. 3 shows AC breakdown results of pure mineral oils, and mineral oils with 5% nano alumina by weight, measured at various drying conditions. It is clearly seen that pure mineral oil is very sensitive to moisture level. The breakdown voltage of pure mineral oil almost doubled after it was degassed for 3 days under full vacuum, while nano mineral oils showed relatively stable breakdown strength values.

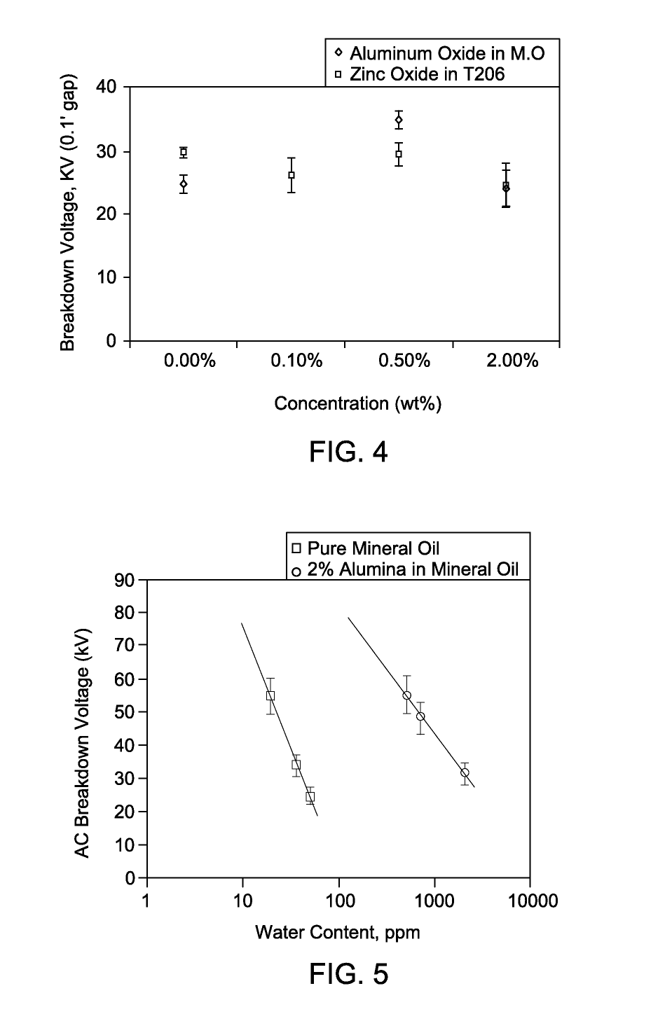

To further understand the moisture effect, another set of samples were made with a controlled humidity environment, and measured for AC breakdown strength. Samples were placed in a sealed container with 84% humidity for two weeks. There was no change in particle dispersion, and no particle settling was noticed after exposure to 84% relative humidity for two weeks. AC breakdown tests were then conducted. FIG. 4 shows the AC breakdown difference between mineral oil alone (i.e. 0.00% nanoparticles) and mineral oil that contained 0.1 wt %, 0.5 wt % and 2 wt % Al₂O₃ and ZnO, after exposure to 84% humidity controlled by potassium chloride. Table 2 shows the water content of various oils as received, conditioned under vacuum and 84% relative humidity respectively.

TABLE 2
Moisture content in mineral oils and nano mineral oils.

| | Water |
|---|---|
| Sample | content ppm |
| 2 wt. % Al₂O₃ in T-206 as received | 4608 |
| T-206 as received | 66 |
| T-206 at 84% relative humidity 1 week | 112 |
| 0.05 wt. % Al₂O₃ in Mineral Oil Vac. Dried for 3 days | 19 |
| Mineral Oil Vac. Dried for 3 days | 20 |
| Mineral Oil as received | 37 |
| Mineral Oil at 84% relative humidity 1 week | 51 |
| 2 Wt. % Al₂O₃ in Mineral Oil Vac. Dried 3 days | 526 |
| 2 Wt. % Al₂O₃ in Mineral Oil | 709 |
| 2 Wt % Al₂O₃ in Mineral Oil 84% relative humidity 1 week | 2128 |

The nano particles prepared as a colloidal solution may contain high moisture content, resulting in high moisture content in nano fluids made using the colloidal solution thereafter. FIG. 5 shows breakdown voltage versus water content. Although nano fluids contain much higher moisture, their AC breakdown values were not significantly degraded, in comparison to pure mineral oils. Nano mineral oils show a much higher tolerance to moisture than the pure mineral oil, which is an important feature for dielectric fluids.

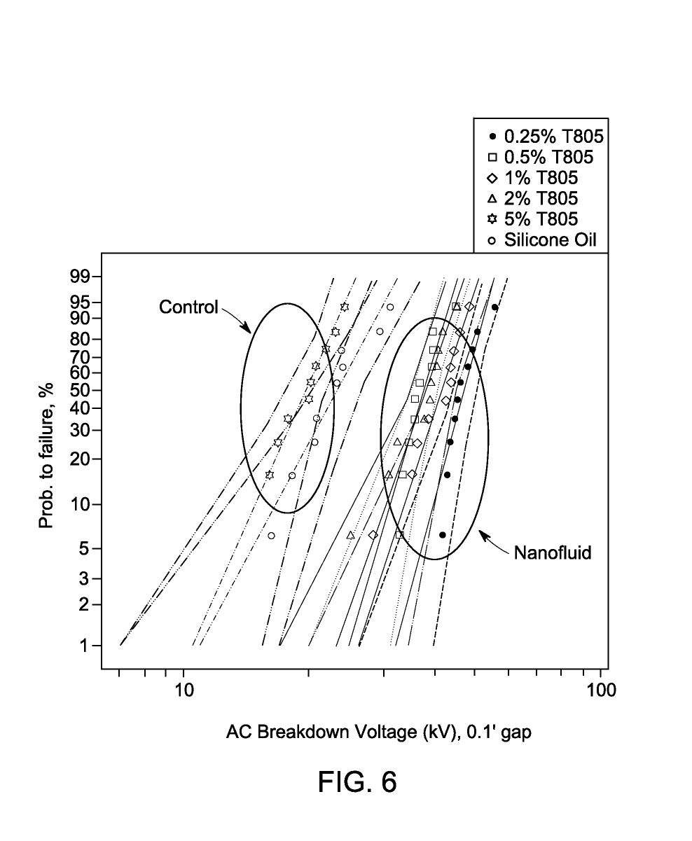

FIG. 6 shows Weibull plots of AC breakdown values for silicone oils, with and without TiO₂ nano particles. The addition of a small percentage of TiO₂ increased the AC breakdown values for the silicone oil by almost 80%.

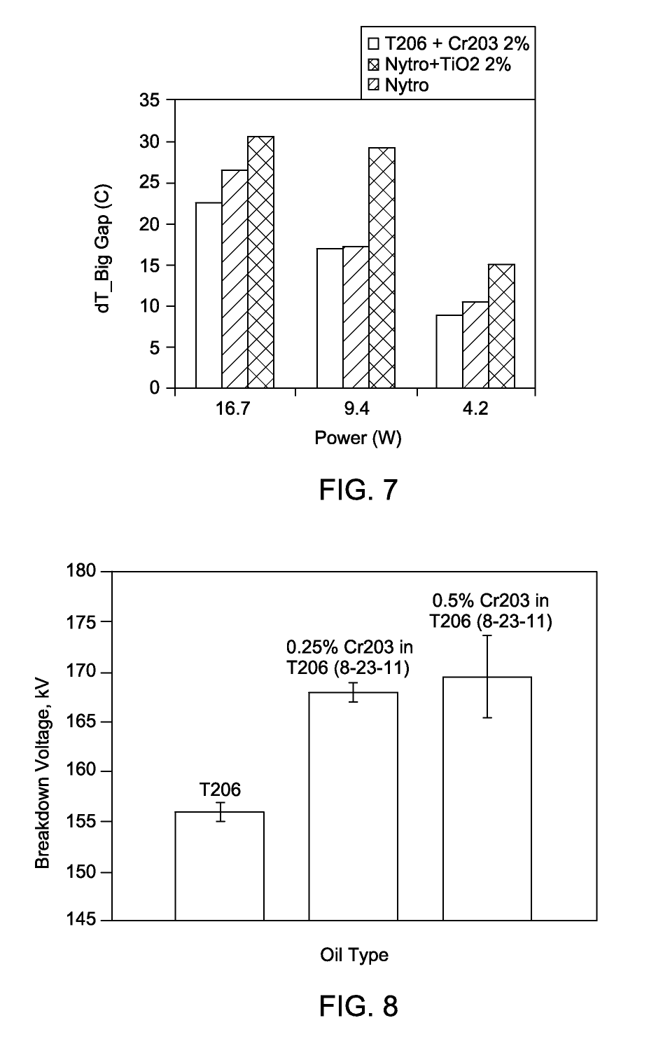

FIG. 7 shows the temperature differences between averaged TC outputs from heat plate and the cold plate, at different power levels. Generally, this difference increased with increasing input power level. The temperature difference is the highest with pure transformer oil, for example Nytrol oil or T206 oil, and the lowest with 2 Wt % Cr₂O₃ and 2 Wt % TiO₂ respectively.

FIG. 8 shows that with less than about 2 Wt. % chromium oxide in T206 mineral oil, the negative impulse breakdown voltage is increased.

Overall, the addition of a small amount of nano particles in transformer oils was found to increase the dielectric performance, especially its AC breakdown strength with moisture being present. This will aid in enhancing the service life of transformers and other electrical devices.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fluid, comprising:
(i) about 95 Wt % to about 99.9 Wt % of an insulating liquid; and
(ii) about 0.1 Wt % to about 5 Wt % of insulating, inorganic, non-magnetic nanoparticles.

2. The fluid of claim 1, wherein the insulating liquid comprises a mineral oil, a high molecular weight hydrocarbon oil, a silicone oil, a vegetable oil, a synthetic ester oil, a natural ester oil, a synthetic hydrocarbon liquid, a perfluoropolymer liquid, or any combination thereof.

3. The fluid of claim 2, wherein the electrical conductivity of the insulating liquid is less than about 10⁻¹⁰ S/m.

4. The fluid of claim 1, wherein the insulating, inorganic, non-magnetic nanoparticles comprise aluminum oxide, chromium oxide, titanium oxide, magnesium oxide, silicon oxide, or any combination thereof.

5. The fluid of claim 4, wherein the electrical conductivity of the insulating, inorganic, non-magnetic nanoparticles is less than about 10⁻⁴ S/m.

6. The fluid of claim 4, comprising about 1 Wt % to about 2 Wt % of chromium oxide.

7. The fluid of claim 4, wherein the fluid comprises from about 1 Wt % to about 4 Wt % of aluminum oxide.

8. The fluid of claim 4, wherein the fluid comprises from about 1 Wt % to about 2 Wt % of titanium oxide.

9. The fluid of claim 1, wherein the insulating, inorganic, non-magnetic nanoparticles have an average size in the range from about 1 nm to about 100 nm.

10. The fluid of claim 9, wherein the insulating, inorganic, non-magnetic nanoparticles have an average size in the range from about 5 nm to about 50 nm.

11. The fluid of claim 1, wherein the insulating, inorganic, non-magnetic nanoparticles are coated with a hydrophobic surfactant.

12. The fluid of claim 11, wherein the hydrophobic surfactant comprises a fatty acid, a silane, a polymer, or any combination thereof.

13. The fluid of claim 1, wherein the hydrophobic surfactant comprises oleic acid.

14. An electrical apparatus, comprising:
an electrical insulation system comprising a dielectric fluid, wherein the dielectric fluid comprises
(i) about 95 Wt % to about 99.9 Wt % of an insulating liquid; and
(ii) about 0.1 Wt % to about 5 Wt % of insulating, inorganic, non-magnetic nanoparticles.

15. The electrical apparatus of claim 14, in the form of an electrical voltage transformer.

16. An electrical transformer, comprising:
an electrical insulation system comprising a dielectric fluid, wherein the dielectric fluid comprises
(i) about 97 Wt % to about 99.5 Wt % of a transformer oil, and
(ii) about 0.5 Wt % to about 3 Wt % of nanoparticles comprising aluminum oxide, titanium oxide, magnesium oxide, chromium oxide, or a combination thereof.
